(19) United States
(12) Patent Application Publication
(10) Pub. No.: US 2012/0048296 A1
(43) Pub. Date: Mar. 1, 2012

(54) Cleaning Method for Wafer

(76) Inventors: Wen-Chin Lin, Tainan County (TW); Kai-Chun Yang, Tainan County (TW); Jen-Chieh Lin, Kaohsiung City (TW); Jeng-Yu Fang, Taipei County (TW); Chia-Lin Hsu, Tainan City (TW); Teng-Chun Tsai, Tainan City (TW); Wei-Che Tsao, Tainan City (TW)

(21) Appl. No.: 12/868,726

(22) Filed: Aug. 26, 2010

(51) Int. Cl. B08B 7/00; B08B 3/00

(52) U.S. Cl. 134/6; 134/26

(57) ABSTRACT

A cleaning method for a wafer is provided. First, a first cleaning process is performed wherein the first cleaning process includes providing a cleaning solution having a first concentration. Next, a second cleaning process is performed, wherein the second cleaning process includes providing the cleaning solution having a second concentration. The second concentration is substantially greater than the first concentration. Next, a post-cleaning process is performed to provide dilute water.

### BACKGROUND OF THE INVENTION

1. Field of the Invention

The present invention relates to a cleaning method, and more particularly, to a cleaning method used after a CMP process to clearly remove the slurry used in the CMP process.

2. Description of the Prior Art

The chemical mechanical polishing (CMP) process is one of the most common and the most essential planarization processes to date. The CMP process aims to topographically planarize a thin film disposed on a wafer surface so as to ensure the wafer has a smooth surface. For fabrication of damascene metal connection wires, such as copper conduction wires, the CMP process is an irreplaceable process.

In general, CMP is a process that utilizes the reagent within slurry to react chemically with the front face of a wafer and produce an easily polished layer. Together with the abrasive action provided by the abrasive particles in the slurry above a polishing pad, the protruding portion of the easily polished layer is gradually removed. By repeating the foregoing chemical reaction and mechanical polishing steps, the surface of the wafer is planarized.

However, the slurry is highly corrosive and viscous and is easy to be retained on the surface of the copper. If the slurry is not removed after the CMP process, the slurry residues may cause a lot of problems such as the crater-defect when performing the lithography process, which will affect the quality of the wafer and thus decrease the yields of the wafer. Nevertheless, conventional post-CMP cleaning process dose not provide sufficient cleaning ability to remove the slurry. Consequently, a post-CMP cleaning process that can clearly remove the slurry on the wafer is still needed.

### SUMMARY OF THE INVENTION

One objective of the present invention is to provide a cleaning method that can clearly remove the slurry and prevent the problems of crater-defect in conventional arts.

According to one embodiment of the present invention, a cleaning method for a wafer is provided. First, a first cleaning process is performed wherein the first cleaning process includes providing a cleaning solution having a first concentration. Next, a second cleaning process is performed, wherein the second cleaning process includes providing the cleaning solution having a second concentration. The second concentration is substantially greater than the first concentration. Next, a post-cleaning process is performed to provide dilute water.

By performing different cleaning steps with gradient concentrations, the cleaning process in the present invention can clearly remove unwanted stuff from the surface of the wafer to ensure the clearance of the wafer thereby improving the yields of the wafer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flow chart diagram of the post-CMP cleaning method according to the first embodiment of the present embodiment.

FIG. 2 illustrates a flow chart diagram of the post-CMP cleaning method according to the second embodiment of the present embodiment.

### DETAILED DESCRIPTION

To provide a better understanding of the presented invention, preferred embodiments will be made in details. The preferred embodiments of the present invention are illustrated in the accompanying drawings with numbered elements.

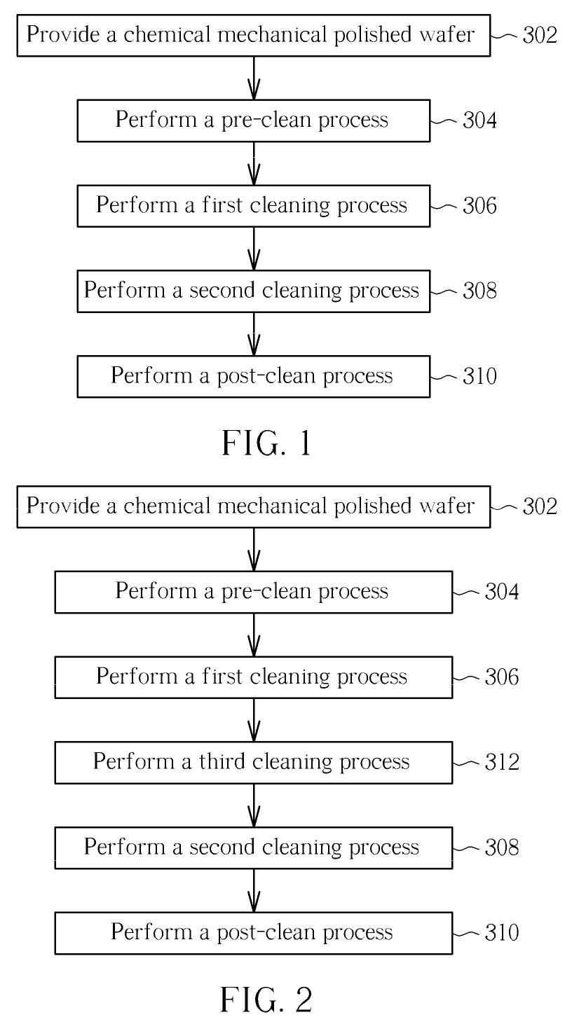

Please refer to FIG. 1, illustrating a flow chart diagram of the post-CMP cleaning method according to the first embodiment of the present embodiment. As shown in FIG. 1, the post-CMP cleaning process in the present embodiment includes the steps as follows. First, a chemical mechanical polished wafer is provided (step 302). The wafer can include any semiconductor structures disposed thereabove, for example, a CMOS, an STI, an interconnection structure, a photodiode or a micro-electro-mechanical system (MEMS). The wafer has been subjected to a CMP process to polish the layers on the surface of the semiconductor structure and the slurry remained on the wafer should be removed.

Next, a pre-clean process is performed (step 304). In the pre-clean process, a cleaning solution is provided on the chemical mechanical polished wafer. The recipe of the cleaning solution can be adjusted according to different types of slurry used in the CMP processes. In the present embodiment, the cleaning solution includes organic amine, quaternary ammonium hydroxide or other suitable cleaning solutions that are able to remove the slurry, and should not be limited thereto. The cleaning solution is supplied unto the wafer, for example, by a delivery pipe, and then mixed with DI water which is supplied from another deliver pipe. The volume dilution ratio of the cleaning solution in the pre-clean process is substantially between 1:45 and 1:100. In one embodiment, about 2000 ml DI wafer and about 25 ml cleaning solution are mixed, leading to a 1:85 volume dilution ratio. In another embodiment, about 2400 ml DI wafer and about 25 ml cleaning solution are mixed, leading to a 1:95 volume dilution ratio. It is noted the pre-clean process is taken as a rinse process, so only the cleaning solution is applied to the wafer but no brush process is performed. That is, the brush does not contact the surface of the wafer during the pre-clean step. In the present embodiment, the pre-clean step is preformed for about 10 seconds.

Next, a first cleaning process is performed (Step 306). In the first cleaning process, the cleaning solution having a first concentration is provided on the surface of the wafer. In the present embodiment, the first concentration is substantially the same as the concentration used in the pre-clean process. In another embodiment, the first concentration of the cleaning solution is greater than the concentration used in the pre-clean process. The first cleaning process includes a brush process. That is, during the first cleaning process, the cleaning solution is supplied and the wafer is brushed simultaneously so as to clearly remove the slurry. In one embodiment, the brush process is performed during whole first cleaning process, and in another embodiment, the brush process is performed within a period of time during the first cleaning process. In the present embodiment, the first cleaning step (step 306) is preformed for about 20 seconds.

Subsequently, a second cleaning process is performed (Step 308). In the second cleaning process, the cleaning solution having a second concentration is provided on the wafer. It is one salient feature in the present invention that the second concentration in the second cleaning process is greater than the first concentration in the first cleaning process. That is, a lower concentration of cleaning solution is used first (the first cleaning process), and then a higher concentration of cleaning solution is used (the second cleaning process). In one preferred embodiment, the volume dilution ratio of the cleaning solution is about 1:45, which can be obtained by mixing about 2000 ml DI water and about 45 ml cleaning solution. In the second cleaning process, like the first cleaning process, the wafer is subjected to the brushing process, which can be performed during whole second cleaning process or only in a period of time. The second cleaning step (step 308) is preformed for about 30 seconds.

Lastly, a post-clean process is performed (Step 310). In the present embodiment, about 4000 ml DI water is provided on the wafer to thoroughly clean the wafer and remove the slurry. In the present embodiment, the wafer is subjected to the brushing process, which can be performed during whole post-clean process or only in a period of time. The post-clean step (step 310) is preformed for about 30 seconds.

According to the present embodiment, by using the cleaning process including the first cleaning process and the second cleaning process where a lower concentration (the first concentration) is used first and a higher concentration (the second concentration) is used subsequently, the slurry of the CMP process can be removed more clearly. Consequently, the defects caused by un-removed slurry can be alleviated. Moreover, the over-etching problem on the wafer in conventional arts which is resulted from directly using only one concentration of the cleaning solution (usually high concentration) can be prevented, thereby maintaining the smoothness of the layers on the semiconductor structure. As the pre-clean process which is performed before the first cleaning process and the second cleaning process provides the cleaning solution on the wafer without brushing the wafer, the slurry on the wafer is bathed within the cleaning solution for about 10 seconds, so the slurry can be removed more easily in the subsequent first cleaning process and second cleaning process, both of which include a brush process to remove away the slurry. After the cleaning process, the post-clean process is still subjected to the brush process to effectively remove the cleaning solution and the remainders. Further, the mixed cleaning solution has a pH value substantially between 12±0.3 (11.07˜12.03) during the post-CMP cleaning method in the present invention and pH value of the cleaning solution is not affected severely by the dilution ratio.

The first embodiment uses two separate cleaning processes with different chemical concentration to clearly remove the slurry. However, it is understood that, between the first cleaning process and the second cleaning process, more than one cleaning process can be performed. For example, please refer to FIG. 2, illustrating a flow chart diagram of the post-CMP cleaning method according to the second embodiment of the present embodiment. As shown in FIG. 2, compared with the first embodiment in FIG. 1, the post-CMP process of the present embodiment further includes a third cleaning process (step 312) performed between the first cleaning process and the second cleaning process. The third cleaning process uses the cleaning solution having a third concentration which is between the first concentration and the second concentration. In this way, a concentration gradient of the cleaning solution from the lowered concentration to the higher concentration can be preformed (the first concentration≦the third concentration≦the second concentration). It is understood that more than one cleaning process can be preformed between the first cleaning process and the second cleaning process. For example, a third cleaning process, a fourth cleaning process, even a fifth cleaning process or other plurality of sub cleaning processes can be performed between the first cleaning process and the second cleaning process. The principle is that each concentration of the cleaning solution used in each cleaning processes between the first cleaning process and the second cleaning process should be in gradient between the first concentration and the second concentration (the first concentration≦the third concentration≦the fourth concentration≦. . . ≦the second concentration). Like the first cleaning process and the second cleaning process, each cleaning process performed therebetween includes a brushing process and is performed for about 20 seconds.

Through the cleaning process in the present invention, the defects such as crater defect caused from the un-removed slurry can be reduced. For example, in conventional arts, each wafer has an average about 10.175 defects caused by un-removed slurry. By using the cleaning process in the present invention, the defect number can be reduced to 2.54, leading to a 75% reduction in defect numbers. Accordingly, the cleaning process in the present invention can effectively decrease the defects caused from un-removed slurry, thereby increasing about 2% yield of the wafer.

In light of above, the present invention provides a cleaning method to solve the problems of crater defect or micro-scratch caused by the un-removed slurry. It is noted that the cleaning steps described above not only can be used in post-CMP process, but also is applicative in other cleaning process, such as the cleaning process after an etching process. By performing different cleaning steps with gradient concentrations, the cleaning process in the present invention can clearly remove unwanted stuff from the surface of the wafer to ensure the clearance of the wafer thereby improving the yields of the wafer.

Those skilled in the art will readily observe that numerous modifications and alterations of the device and method may be made while retaining the teachings of the invention.

What is claimed is:

1. A cleaning method for a wafer, comprising:
performing a first cleaning process, wherein the first cleaning process comprises providing a cleaning solution having a first concentration;
after performing the first cleaning process, performing a second cleaning process, wherein the second cleaning process comprises providing the cleaning solution having a second concentration, the second concentration is substantially greater than the first concentration; and
after performing the second cleaning process, performing a post-clean process, wherein the post clean process comprises providing dilute water.

2. The cleaning method of claim 1, before the first cleaning process further comprising a pre-clean process, wherein the pre-clean process comprises providing the cleaning solution having a pre-clean concentration.

3. The cleaning method of claim 2, wherein the pre-clean process is performed without a brush process.

4. The cleaning method of claim 2, wherein the pre-clean concentration is substantially equal to the first concentration.

5. The cleaning method of claim 2, wherein the pre-clean concentration is substantially less than the first concentration.

6. The cleaning method of claim 2, wherein the pre-clean process is performed for substantially 10 seconds.

7. The cleaning method of claim 1, wherein the volume dilution ratio of the first concentration is substantially between 1:45 and 1:100.

8. The cleaning method of claim 1, wherein the volume dilution ratio of the second concentration is substantially 1:45.

9. The cleaning method of claim 1, wherein both of the first cleaning process and the second cleaning process comprise a brush process.

10. The cleaning method of claim 1, wherein the first process is performed for substantially 20 seconds.

11. The cleaning method of claim 1, wherein the second process is performed for substantially 30 seconds.

12. The cleaning method of claim 1, wherein the post-cleaning process is performed without a brush process.

13. The cleaning method of claim 1, wherein the post-cleaning process is performed for substantially 30 seconds.

14. The cleaning method of claim 1, further comprising more than one sub cleaning process performed between the first cleaning process and the second cleaning process, wherein each concentration of the cleaning solution used in the sub cleaning process is in gradient between the first concentration and the second concentration.

15. The cleaning method of claim 14, wherein each sub cleaning process is performed for substantially 20 seconds.

16. The cleaning method of claim 14, wherein each sub cleaning process includes a brush process.

17. The cleaning method of claim 1, wherein the cleaning solution comprises organic amine or quaternary ammonium hydroxide.

18. The cleaning method of claim 1, wherein the pH value of the cleaning solution is substantially between 11.7 and 12.3.

19. The cleaning method of claim 1, wherein the cleaning method is performed after a CMP process to remove slurry used in the CMP process from the wafer.
